(19) United States
(12) Patent Application Publication
(10) Pub. No.: US 2026/0212285 A1
(43) Pub. Date: Jul. 23, 2026

(54) SYSTEMS AND METHODS FOR PREDICTING FULFILLMENT TIMES AND UPDATING USER REQUESTS

(71) Applicant: Walmart Apollo, LLC, Bentonville, AR (US)

(72) Inventors: Saurabh Shrikrishna Marathe, Sunnyvale, CA (US); Cherry Agarwal, Sunnyvale, CA (US); Wanlan Zeng, Woodcliff, NJ (US); Jing Huang, San Jose, CA (US); Subhangi Nandan, San Jose, CA (US); Lijie Wan, Mountain View, CA (US); Mingang Fu, Palo Alto, CA (US); Indu Mittal, Union City, CA (US); Lakhbir Singh, Jalandhar (IN); Viresh Baswaraj Jivane, Bentonville, AR (US)

(21) Appl. No.: 19/034,036

(22) Filed: Jan. 22, 2025

(51) Int. Cl. G06Q 10/04; G06Q 10/087

(52) U.S. Cl. CPC G06Q 10/04; G06Q 10/087

(57) ABSTRACT

Example implementations relate to predicting fulfillment times for user requests. In an example, a user request including item data, a fulfillment location, and a provisional fulfillment time is received by a system. The system requests, via a fulfillment predictor, fulfillment data for the fulfillment location. The fulfillment data including at least a fulfillment order for the user request and ongoing fulfillment orders for the user request. The system, in response to receiving the fulfillment data, determines, by the fulfillment predictor, a predicted fulfillment time for the user request. The system determines whether a difference between the provisional fulfillment time and the predicted fulfillment time is within a fulfillment time threshold and, in accordance with a determination that the difference between the provisional fulfillment time and the predicted fulfillment time is outside the fulfillment time threshold, transmits the predicted fulfillment time to at least one computing device.

### TECHNICAL FIELD

This application relates generally to predicting fulfillment times, and more particularly, to predicting delivery and/or task completion times that are provided to a user for modifying a user request.

### BACKGROUND

Systems generate estimated fulfillment times when orders are initially received. The estimated fulfillment times are generated using rigid systems that cannot update estimated fulfillment times. Additionally, systems that generate estimated fulfillment times require long processing times, which reduce efficiency, and provide estimated fulfillment times with large variances, which result in user dissatisfaction.

### BRIEF DESCRIPTION OF THE DRAWINGS

Various examples will be described below with reference to the following figures.

FIG. 1 depicts an example system that provides fulfillment predictions, in accordance with some embodiments.

FIG. 2 depicts an example system for generating fulfillment time estimates, in accordance with some embodiments.

FIG. 3 depicts an example training system for a fulfillment predictor, in accordance with some embodiments.

FIG. 4 depicts a system including the fulfillment scheduling system, in accordance with some embodiments.

FIG. 5 depicts a system including the fulfillment scheduling system, in accordance with some embodiments.

FIG. 6 depicts a flow diagram of a method for determining a predicted fulfillment time, in accordance with some embodiments.

FIG. 7 depicts an example method for determining a predicted fulfillment time, in accordance with some embodiments.

FIG. 8 depicts an example method expanding on the method for determining a predicted fulfillment time, in accordance with some embodiments.

FIG. 9 depicts an example system that includes non-transitory, machine-readable media encoded with example instructions executable by processing resource.

FIG. 10 illustrates a block diagram of a computing device, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

The systems and methods disclosed herein provide stable, flexible, and accurate machine learning systems that predict the fulfillment times for user request. For example, the systems and methods disclosed here can predict pick complete time (e.g., estimated time for acquiring items of objects) of a user order for pickup. The systems and methods disclosed herein provide efficient prediction models that can look at existing state of user requests (e.g., on-going orders) and their items; and predict the time of fulfillment (e.g., pick completion), in real time, for remaining items in the user request (e.g. items yet to be picked) considering historical data (e.g., prior indicators like store speed averages, current and past pick rate, commodity type, etc.).

The systems and methods disclosed herein provide machine learning based continuous dynamic prediction systems. The disclosed machine learning system are trained on different snapshots of historical data (e.g., pick status data) as seen at different timestamps thus enabling the machine learning system to function as continuous dynamic prediction systems. The disclosed machine learning systems are trained using training data for different fulfillment time windows. For example, the prepared training data can include snapshots of historical data (e.g., pick status data) at T-40, T-30, T-20, T-15, T-10, T, T+10, T+20; where T is the slot start hour. The training data allows the machine learning systems to capture the dynamic and continuous nature of a user request fulfillment process (e.g., the pick process) and provides the machine learning systems the ability to predict fulfillment times (e.g., pick completion time) from different vantage points. In this way, the machine learning systems can be used to determine predicted fulfillment times for different timestamps like T-40, T-20, T-15, or any other custom timestamp.

The systems and methods disclosed herein provide an accuracy optimized prediction time system for continuous dynamic predictions. The systems and methods disclosed herein determine prediction timestamps that determine a state of a user order (e.g., a state of a pick completion) that can be captured for ongoing orders. The systems and methods disclosed herein derive a predicted fulfillment time that provide accurate predictions for user request fulfillments, while considering the continuous and ever changing in nature of the fulfillment process. In some embodiments, the systems and methods disclosed herein can determine a relationship between prediction time deltas and the effect of a user request fulfillment time and accuracy (e.g., effect on pick completion time prediction accuracy). In some embodiments, accuracy of the machine learning models is based on the different timestamps. In some embodiments, the systems and methods disclosed herein have an average accuracy of at least 70% within 15-minute time window with respect to an actual pick completion time.

In some embodiments, the machine learning system training process includes sampling historical data. In some embodiments, the sampling the historical data reduces a dataset for more than 4000 locations (e.g., stores) and with location data (e.g., picking data) calculated from different prediction timestamps (e.g., T-40, T-20, T-15, etc.). In some embodiments, a training process utilizes 6 months of historical data. In some embodiments, the sampled data reduces a location dataset from a first predetermined number (e.g., more than 5000 stores) to a second predetermined number (e.g., less than 1000, less than 150, less than 100, etc.). The sampling process reduces the training process to no more than 12 hours of runtime, which saves hours of computation time and computation cost. The disclosed systems and methods provide a faster solving time for determining predicted fulfillment times (e.g., solving times of less than 0.2 seconds). In some embodiments, the systems and methods disclosed herein can determine predicted fulfillment times for at least 30,000 user requests simultaneously. In some embodiments, the systems and methods disclosed herein are scalable for different user request numbers, number of location, number of items, etc.

In various embodiments, a system including a processor and a non-transitory memory storing instructions, that when executed, cause the processor to perform one or more operations for predicting fulfillment times is disclosed. The instructions, when executed, cause the processor to receive a user request including item data, a fulfillment location, and a provisional fulfillment time. The instructions, when executed, cause the processor to request, via a fulfillment predictor, fulfillment data for the fulfillment location. The fulfillment data includes at least a fulfillment order for the user request and ongoing fulfillment orders for the user request. The instructions, when executed, cause the processor to, in response to receiving the fulfillment data, determine, by the fulfillment predictor, a predicted fulfillment time for the user request. The predicted fulfillment time is based on at least the fulfillment order for the user request and ongoing fulfillment orders for the user request and defines a time for acquiring items in the item data. The instructions, when executed, cause the processor to determine whether a difference between the provisional fulfillment time and the predicted fulfillment time is within a fulfillment time threshold and, in accordance with a determination that the difference between the provisional fulfillment time and the predicted fulfillment time is outside the fulfillment time threshold, transmit the predicted fulfillment time to at least one computing device.

In various embodiments, a computer-implemented method for predicting fulfillment times is disclosed. The computer-implemented method includes receiving a user request including element data, a fulfillment location, and a provisional fulfillment time. The computer-implemented method includes requesting, via a fulfillment predictor, fulfillment data for the fulfillment location. The fulfillment data includes at least a fulfillment order for the user request and ongoing fulfillment orders for the user request. The computer-implemented method includes, in response to receiving the fulfillment data, determining, by the fulfillment predictor, a predicted fulfillment time for the user request. The predicted fulfillment time is based on at least the fulfillment order for the user request and ongoing fulfillment orders for the at least one other user request and defines a time for acquiring elements in the element data. The computer-implemented method includes determining whether a difference between the provisional fulfillment time and the predicted fulfillment time is within a fulfillment time threshold and, in accordance with a determination that the difference between the provisional fulfillment time and the predicted fulfillment time is outside the fulfillment time threshold, transmitting the predicted fulfillment time to at least one computing device.

In various embodiments, a non-transitory computer readable medium having instructions for predicting pickup times stored thereon is disclosed. The instructions, when executed by at least one processor, cause the at least one device to perform operations including receiving a user request including element data, a pickup location, and a provisional pickup time. The instructions, when executed by at least one processor, cause the at least one device to perform operations including requesting, via a pickup predictor, pickup data for the pickup location. The pickup data includes at least a pickup order for the user request and ongoing pickup orders for the user request. The instructions, when executed by at least one processor, cause the at least one device to perform operations including, in response to receiving the pickup data, determining, by the pickup predictor, a predicted pickup time for the user request. The predicted pickup time is based on at least the pickup order for the user request and ongoing pickup orders for the user request and defines a time for acquiring elements in the element data. The instructions, when executed by at least one processor, cause the at least one device to perform operations including determining whether a difference between the provisional pickup time and the predicted pickup time is within a pickup time threshold and, in accordance with a determination that the difference between the provisional pickup time and the predicted pickup time is outside the pickup time threshold, transmitting the predicted pickup time to at least one computing device.

Furthermore, in the following, various embodiments are described with respect to methods and systems for estimating or predicting pickup times or fulfillment times for user requests. In some embodiments, a “pickup time,” as described herein, means a particular or scheduled time for a user to obtain or collect one or more items associated with a user request. In some embodiments, “fulfillment time,” as described herein, means a particular or scheduled time for completing tasks associated with a user request. In various embodiments, a user request is received by a system. The user request, such as a purchase order, an item request, an element request, an acquisition request, etc., includes information for fulfilling the user request. Information for fulfilling the user request can include item data, purchase data, a fulfillment or pickup location, an estimated or provisional fulfillment (or pickup) time, and/or other data for determining a predicting pickup or fulfillment times for the user request. When the user request is received, the request is provided to a model that dynamically determines predicted pickup or fulfillment times for the user request based, in part, on ongoing fulfillments at the location, historical fulfillment times, personnel at that location and/or other data. The methods and systems for estimating or predicting pickup or fulfillment times for user requests can determine predicted fulfillment times for different time windows. Compared to existing solutions, which provide static fulfillment time estimates, the methods and systems disclosed herein allow for dynamic determinations of predicted fulfillment times. The methods and systems disclosed herein are improve accuracy in predicted fulfillment times and are scalable to cover multiple locations. Additionally, the methods and systems disclosed allow for faster determinations of predicted fulfillment times, reduce overall computational needs, and allow for real-time determinations compared to existing methods (which involved extensive and/or laborious calculations).

In some embodiments, systems, and methods for predicting pickup or fulfillment times for user requests includes one or more trained machine learning models. The trained machine learning models may include one or more models, such as gradient boosted decision trees, supervised learning models, unsupervised learning models, semi-supervised learning models, semi-unsupervised learning models, convolutional neural networks, recurrent neural networks, deep neural networks, artificial neural networks, and/or other models in the field.

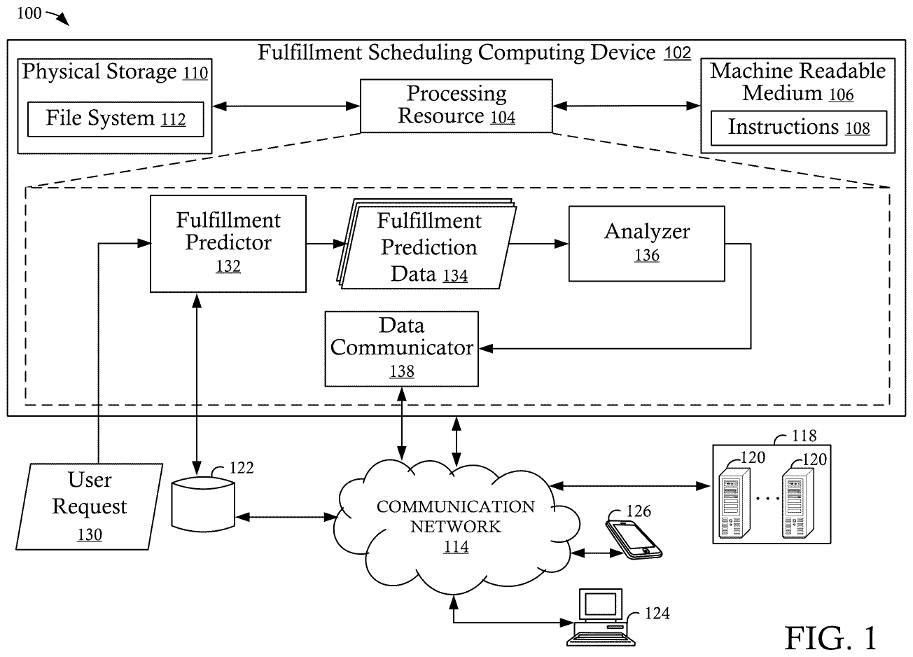

FIG. 1 depicts an example system 100 that provides fulfillment predictions, in accordance with some embodiments. The system 100 includes a fulfillment scheduling computing device 102 that provides fulfillment predictions for a user request (e.g., a purchase order, an item request, element request, acquisition request, product request, etc.). The fulfillment scheduling computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The fulfillment scheduling computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the fulfillment scheduling computing device 102, such as receiving a user request, prompting, or requesting fulfillment data, determining deviations in data, and providing notifications. The instructions 108 may include instructions for implementing one or more models. In some embodiments, and as will be described further herein below, the fulfillment scheduling computing device 102 may execute one or more models, processes, or algorithms, such as a machine learning model, deep learning model, statistical model, etc., (e.g., as implemented as machine readable instructions) to predict fulfillment times.

The fulfillment scheduling computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the fulfillment scheduling computing device 102. In some implementations, physical storage 110 may be accessed as a block storage device.

In some cases, the fulfillment scheduling computing device 102 may also include a local file system 112 that may be implemented as a layer on top of the physical storage 110. For example, an operating system 112 may be executing on the fulfillment scheduling computing device 102 (by virtue of the processing resource 104 executing certain instructions 108 related to the operating system) and the operating system 112 may provide a file system 112 to store data on the physical storage 110.

The fulfillment scheduling computing device 102 may be in communication with one or more additional devices over one or more network channels or network 114. For example, in various embodiments, the fulfillment scheduling computing device 102 may be in communication with a web server (not shown), a cloud-based engine 118 including one or more processing devices 120 that may be provisioned for use, a database 122, a workstation 124, and/or any other suitable system or device. The fulfillment scheduling computing device 102 may similarly be in communication, either directly or indirectly, with one or more user computing devices 126 operatively coupled over the network 114. The other computing systems may be similar to the fulfillment scheduling computing device 102, and may each include at least a processing resource and a machine readable medium.

In some embodiments, the fulfillment scheduling computing device 102, such as the processing resource 104, implements a fulfillment predictor 132 that receives a user request 130. The user request can be a purchase order, item request, element request, a product order, a service request, and/or any other request for service, assistance, and/or acquisition for an object. The user request 130 can include item data, a fulfillment location, and/or a provisional fulfillment time (an initial estimated fulfillment time). In some embodiments, the user request includes element data, service data, product data, a pickup location, a service location, completion location, a provisional completion time, a provisional pickup time, a desired fulfillment time and/or window, etc.

In some embodiments, the user request 130 is received from a user computing device 126. In some embodiments, a user submits the user request 130 on a website hosted by the web server 116. The web server 116 may send the user request 130 to the fulfillment scheduling computing device 102. In response to receiving the user request 130, the fulfillment scheduling computing device 102 may execute one or more processes to determine a predicted fulfillment time as discussed below. In some embodiments, the fulfillment scheduling computing device 102 transmits the predicted fulfillment time (and/or other data) to the web server 116 to be displayed to the user. Alternatively, or in addition, in some embodiments, the user request 130 is received from a cloud-based engine 118 including one or more processing devices 120 that may be provisioned for use, a workstation 124, and/or any other suitable system or device. In some embodiments, the fulfillment predictor 132 validates the user request 130. Alternatively, or in addition, in some embodiments, the user request 130 is validated before it is received by the fulfillment predictor 132 and the fulfillment predictor 132 receives validation information.

The fulfillment predictor 132 can generate a request (or a prompt) for fulfillment data. In some embodiments, the request for fulfillment data is based on the user request 130. The fulfillment predictor 132 requests the fulfillment data from database 122 and/or one or more databases. In some embodiments, the fulfillment predictor 132 requests the fulfillment data from one or more remote web servers, cloud-based engines 118, workstations 124, and/or any other suitable system or device. The fulfillment data can include at least a fulfillment order for the user request and ongoing fulfillment orders for the user request. The fulfillment orders can include information on pending user requests at a location, a priority for pending user requests, an order for fulfilling pending user requests, average fulfillment times, location personnel information, time of day, busy periods, inventory information, search times, average search times, and/or other information.

The fulfillment predictor 132 generates fulfillment prediction data 134 based on the user request 130 and/or received fulfillment data. The fulfillment prediction data 134 includes a predicted fulfillment time for the user request. The fulfillment predictor 132 determines the predicted fulfillment time for the user request based on at least the fulfillment order for the user request and ongoing fulfillment orders for the user request. In some embodiments, the predicted fulfillment time defines a time for acquiring items in the item data. In some embodiments, the fulfillment predictor 132 has an average accuracy of at least 70% within 15-minute time window with respect to an actual pick completion time. In some embodiments, the fulfillment predictor 132 provides a value for the predicted time having an accuracy rate of a predefined threshold value within a predefined time window with respect to an actual pick completion time. For example, a value for a predicted time within a 15-minute time window with respect to an actual pick completion time can have an accuracy rate of a predefined threshold value (e.g., 65% to 75%). In another example, a value for a predicted time within a 20-minute time window with respect to an actual pick completion time can have an accuracy rate of another predefined threshold value (e.g., 60% to 70%).

The fulfillment prediction data 134 can include suggested modifications to the user request 130. For example, the fulfillment prediction data 134 can include availability information (e.g., product, item, element, etc. availability), alternative information (e.g., alternative or substitute products, items, elements, etc. and/or alternative suggested times), and/or other information for fulfilling the user request 130.

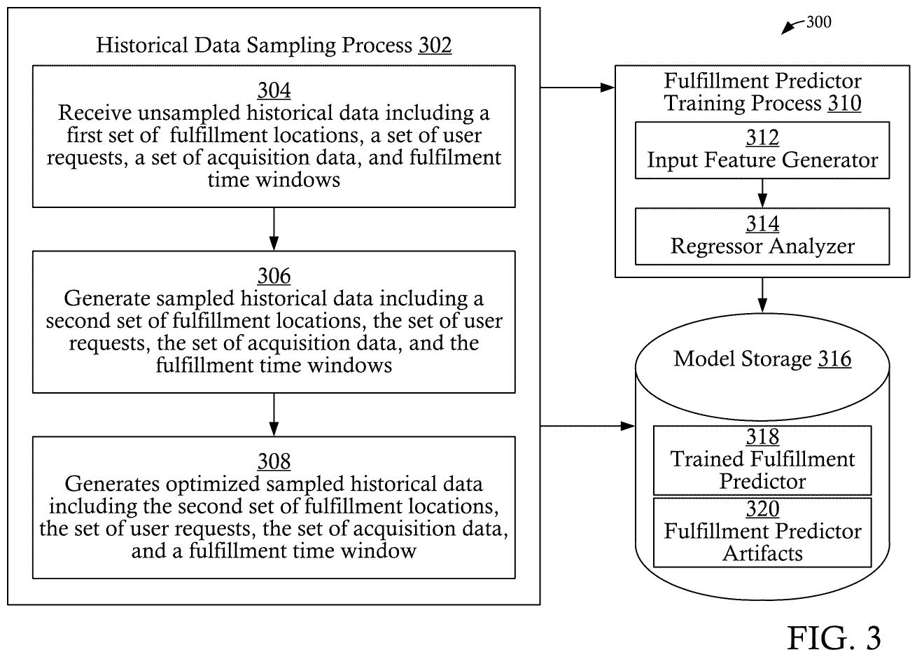

In some embodiments, the fulfillment predictor 132 is trained using historical data for a period of time. The historical data includes a set fulfillment locations, a set of user requests, a set of acquisition data for the set of user requests, and one or more fulfillment time windows. In some embodiments, the historical data is sampled to decrease the set fulfillment locations and decrease a training time of the fulfillment predictor. Training of the fulfillment predictor 132 is discussed below in reference to FIG. 3.

The analyzer 136 is configured to receive a predicted fulfillment time and determine whether a difference between the provisional fulfillment time and the predicted fulfillment time is within a fulfillment time threshold. In accordance with a determination that the difference between the provisional fulfillment time and the predicted fulfillment time is outside the fulfillment time threshold, the data communicator 138 transmit the predicted fulfillment time to at least one computing device. In some embodiments, transmitting the predicted fulfillment time to the at least one computing device includes presenting, at the at least one computing device, one or more options for adjusting the provisional fulfillment time. Alternatively, or in addition, in some embodiments, presenting, at the at least one computing device, the one or more options for adjusting the provisional fulfillment time includes presenting a first user interface element for acknowledging an adjusted fulfillment time; and a second user interface element for requesting assistance regarding completion of the user request. Alternatively, in accordance with a determination that the difference between the provisional fulfillment time and the predicted fulfillment time is within the fulfillment time threshold, the data communicator 138 forgoes transmitting the predicted fulfillment time to at least one computing device.

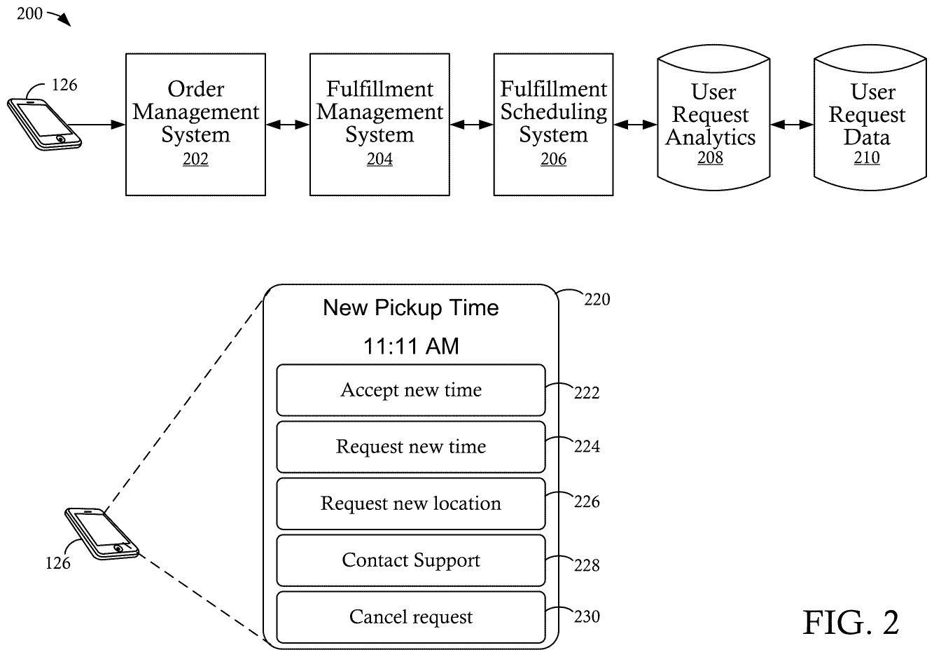

FIG. 2 depicts an example system for generating fulfillment time estimates, in accordance with some embodiments. The system 200 is another example of the fulfillment time predictor system described above in reference to FIG. 1. The system 200 includes an order management system 202, a fulfillment managements system 204, a fulfillment scheduling system 206, user request analytics 208, and user request data 210. One or more user computing devices 126 are communicatively coupled with the system 200 via the order management system 202.

The order management system 202 receives one or more user requests 130 (FIG. 1). The user requests 130 can be received from a website hosted by the web server 116. Alternatively, or in addition, in some embodiments, the order management system 202 receive the user request 130 from a cloud-based engine 118 including one or more processing devices 120 that may be provisioned for use, a workstation 124, and/or any other suitable system or device. The order management system 202 provides the user requests 130 to the fulfillment management system 204.

The fulfillment management system 204 receives the user request 130 and generates a purchase order. The purchase order includes item data, a fulfillment location, and/or a provisional fulfillment time. In some embodiments, the purchase order includes additional information for determining a predicted fulfillment time described above in reference to FIG. 1. The fulfillment management system 204 provides the purchase order to the fulfillment scheduling system 206.

The fulfillment scheduling system 206 is analogous to the fulfillment scheduling computing device 102 (FIG. 1). The fulfillment scheduling system 206 receives the purchase order to determine a predicted fulfillment time. In particular, the fulfillment scheduling system 206, in response to receiving the purchase order, requests from one or more databases (e.g., the user request analytics 208 and/or user request data 210) fulfillment data. The fulfillment data can include at least a fulfillment order for the user request, ongoing fulfillment orders for the user request, and/or other information described above in reference to FIG. 1. The fulfillment scheduling system 206 uses the user request and the fulfillment data to determine, as least, the predicted fulfillment time and other fulfillment prediction data 134. The fulfillment scheduling system 206 provides the fulfillment prediction data 134 to a user via the order management system 202 and the fulfillment management system 204. The fulfillment prediction data 134 can be presented to a user via a user interface, a website, a message, a notification, etc.

The user request analytics 208 includes analytics based on the user request data 210. The analytics based on the user request data 210 can include pick rates, pick accuracy rates, pick speed, pick status, search times, average search times, weekly status, monthly status, yearly status, and/or other information related to fulfilling a user request. “Pick” as described herein, in some embodiments, is retrieval of an item or an element (e.g., picking an object from inventory or a shelf). The user request data 210 stores data for fulfilling a user request. The user request data can include location information, inventory information, location activity data (e.g., down times, busy or peak times), operating times, attrition data, and/or other information for fulfilling a user request.

FIG. 2 further shows a user interface 220 presented at a user computing device 126. The user interface can include one or more options for adjusting the provisional fulfillment time. For example, as shown in user interface 220, a user can be presented with a user interface element for requesting a new time (e.g., second user interface element 224), requesting a new location (e.g., third user interface element 226), and/or requesting assistance for fulfilling a user request (e.g., fourth user interface element 228). The user interface 220 can include one or more additional options for adjusting the provisional fulfillment time. For example, the user interface 220 can include user interface elements for acknowledging an adjusted fulfillment time (e.g., first user interface element 222) or canceling a user request (e.g., fifth user interface element 230).

FIG. 3 depicts an example training system for a fulfillment predictor, in accordance with some embodiments. The training system 300 includes a historical data sampling process 302, a fulfillment predictor training process 310, and model storage 316. As described above in reference to FIG. 1, the fulfillment predictor is trained using historical data for a period of time. The historical data can include a set fulfillment locations, a set of user requests, a set of acquisition data for the set of user requests, and one or more fulfillment time windows. In some embodiments, the period of time can be 1 month, 3 months, 6 months, a year, etc.

The historical data sampling process 302 samples the historical data to decrease the set fulfillment locations and decrease a training time of the fulfillment predictor. For example, the historical data sampling process 302 receives (304) unsampled historical data including a first set of fulfillment locations, a set of user requests, a set of acquisition data, and one or more fulfillment time windows. The first set of fulfillment locations can include a first predetermined number of locations for completing the user request, such as stores, drop-off locations, pickup locations, service centers, etc. The set of user requests can include user orders, user request, and/or purchase orders for a predefined time period (e.g., one day). The set of acquisition data for the set of user requests can include pick session data (e.g., pick speed, pick accuracy, pick order, and/or other pick data) for each user order or user request. The one or more fulfillment time windows include predicted fulfillment time windows (e.g., T-15, T-20, T-40, etc. ; where T is a slot hour, expected time, or provisional fulfillment time).

The historical data sampling process 302 generates (306) sampled historical data including a second set of fulfillment locations, the set of user requests, the set of acquisition data, and the fulfillment time windows. The second set of fulfillment locations can include a second predetermined number of locations for completing the user request. The second predetermined number of locations for completing the user request is less than the first predetermined number of locations for completing the user request. The historical data sampling process 302 further generates (308) optimized sampled historical data including the second set of fulfillment locations, the set of user requests, the set of acquisition data, and a fulfillment time window. The optimized sampled historical data includes a selected fulfillment time window of the one or more the fulfillment time windows with an accuracy satisfying an accuracy threshold (e.g., 60%, 70%, etc.). In some embodiments, the fulfillment time window with the highest accuracy is selected. In some embodiments, the selected fulfillment time window is T-15 or a 15-minute fulfillment time window from a slot hour, expected time, or provisional fulfillment time. In some embodiments, the fulfillment predictor 132 has an average accuracy of at least 70% within 15-minute time window with respect to an actual pick completion time.

An output of the historical data sampling process 302 (e.g., the optimized sampled historical data) is provided to the fulfillment predictor training process 310 and the model storage 316. The fulfillment predictor training process 310 provides the optimized sampled historical data to an input feature generator 312. The input feature generator 312 generates one or more features for the fulfillment predictor 132. Non-limiting examples of features for a fulfillment predictor 132 include one or more pick rates (e.g., before, after, and/or during determination of a predicted fulfillment time), temperature constraints (e.g., item temperature constraints, ambient temperature, etc.), pick times (e.g., pick time before predictions, pick starting time, pick end times, etc.), provisional fulfillment times (e.g., initial estimated fulfillment time, assigned time slot for fulfilling a user request, etc.), pick status (e.g., item or element picked, not picked, not found, etc.), mean pick times, mean pick speeds, quantity in a user request or purchase order (e.g., number of items or elements included in a user request 130 or purchase order), location mean (e.g., mean location pick time), order time or order period (e.g., period of time or time frame in which an order data or the user request is assigned to (e.g., weekly orders, monthly orders, daily orders, etc.)), item pick frequency (e.g., instances an item or element was picked within a predetermined period (e.g., a week)), standard deviation data (e.g., pick speed standard deviations, location standard deviations, etc.), maximum pick capacity for a location, data capture date, and commodity data. In some embodiments, each feature is provided a respective weight for determining a predicted fulfillment time.

The one or more features generated by the fulfillment predictor 132 are provided to a regressor analyzer 314. In some embodiments, the regressor analyzer 314 is a supervised machine learning algorithm for classification and regression. In some embodiments, the regressor analyzer 314 utilizes extreme gradient boosting and/or a method based on decision tree. The regressor analyzer 314 generates a trained fulfillment predictor 132 that is stored in model storage 316 (e.g., in trained fulfillment predictor database 318).

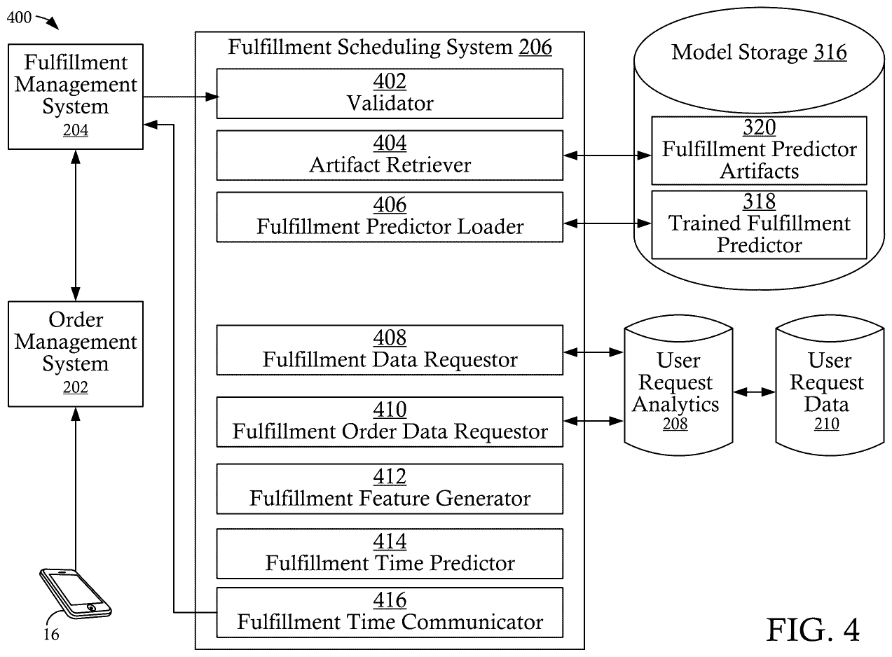

The model storage 316 includes the trained fulfillment predictor database 318 and fulfillment predictor artifacts database 320. The trained fulfillment predictor database 318 includes different trained fulfillment predictors. The different trained fulfillment predictors include fulfillment predictors for different fulfillment time windows, different predetermined number of locations for completing the user request, different number of user requests, different acquisition data, and/or variations in the sampled historical data. The fulfillment predictor artifacts database 320 includes specific files or pieces of data that represents a product of the software development process (e.g., a compiled code package, test results, or configuration files). The artifacts can be byproducts of software development that help describe the architecture, design, and function of software. Fulfillment predictor artifacts can be fetched from the fulfillment predictor artifacts database 320 for loading a fulfillment predictor as described below in reference to FIG. 4. The fulfillment predictor artifacts database 320 can include artifacts related to commodity code files, location average speed files, item related code files, location related code files, and/or other artifacts.

FIG. 4 depicts a system including the fulfillment scheduling system, in accordance with some embodiments. In particular, system 400 illustrates one or more components of the fulfillment scheduling system 206. The system 400 includes an order management system 202, a fulfillment managements system 204, the fulfillment scheduling system 206, user request analytics 208, and user request data 210 described above in reference to FIG. 2. The system 400 also includes the model storage 316 for enabling a fulfillment predictor 132. As described above in reference to FIG. 2, the order management system 202 receives one or more user requests 130 (FIG. 1) and provides the user request 130 to the fulfillment management system 204. The fulfillment management system 204 generates one or more purchase orders that are provided to the fulfillment scheduling system 206.

The fulfillment scheduling system 206, in response to the receiving the one or more purchase orders, uses a validator 402 to validate the purchase order and/or the user request 130. In some embodiments, the fulfillment scheduling system 206 does not determine a predicted fulfillment time until the purchase order and/or the user request 130 is validated. The fulfillment scheduling system 206, after validating the purchase order and/or the user request 130, uses an artifact retriever 404 to fetch one or more artifacts from the fulfillment predictor artifacts database 320 from module storage 316. In some embodiments, the artifact retriever 404 retrieves a plurality of artifacts from the fulfillment predictor artifacts database 320. For example, the artifact retriever 404 can retrieve at least commodity code files and location average speed files from the fulfillment predictor artifacts database 320.

The fulfillment scheduling system 206 utilizes a fulfillment predictor loader 406 to load a fulfillment predictor from the fetched artifacts and/or a trained fulfillment predictor from the trained fulfillment predictor database 318. The fulfillment scheduling system 206 uses a loaded fulfillment predictor (e.g., analogous to fulfillment predictor 132; FIG. 1) to determine a predicted fulfillment time as described above in reference to FIGS. 1 and 2. In particular, the fulfillment scheduling system 206 uses a fulfillment data requestor 408 to requests (or prompt) from at least the user request analytics 208 and/or user request data 210 fulfillment data. In some embodiments, the fulfillment scheduling system 206 uses a fulfillment order data requestor 410 to request (or prompt) fulfillment order data from at least the user request analytics 208 and/or user request data 210.

The fulfillment scheduling system 206 further utilizes a fulfillment feature generator 412 to generate one or more features based on the purchase order, user request, fulfillment data, and/or the fulfillment order data. The one or more derived features are used as inputs to the loaded fulfillment predictor (e.g., via a fulfillment time predictor 414) for determining the predicted fulfillment time. The fulfillment scheduling system 206 can further use a fulfillment time communicator 416 to communicate the predicted fulfillment time to the fulfillment management system 204 as described above in reference to FIG. 2.

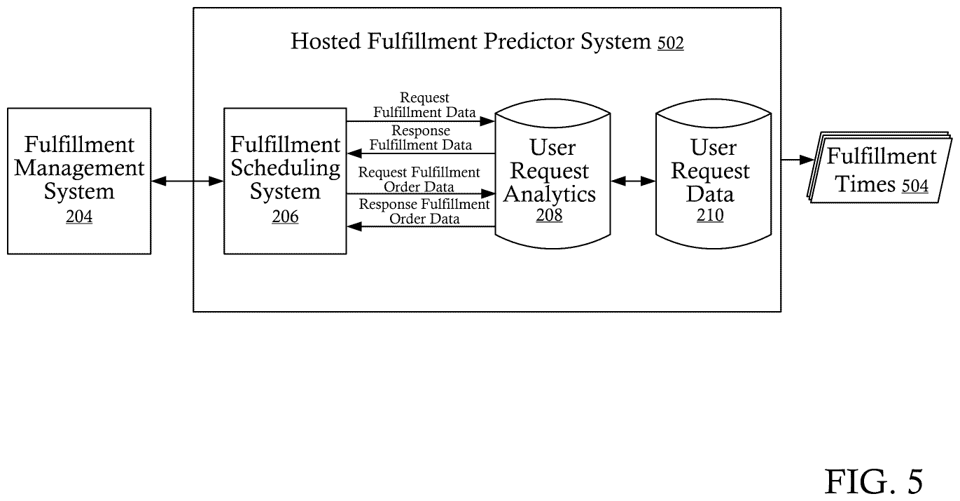

FIG. 5 depicts a system including the fulfillment scheduling system, in accordance with some embodiments. In particular, FIG. 5 illustrates a hosted fulfillment predictor system 502. The hosted fulfillment predictor system 502 determines one or more predicted fulfillment times as discussed above in reference to FIGS. 1-4. For example, the hosted fulfillment predictor system 502 can receive one or more purchase orders and/or user requests from an order management system (not shown) and a fulfillment managements system 204. The received purchase orders and/or user requests are used by a fulfillment scheduling system 206 to request data from the user request analytics 208 and user request data 210 databases. The fulfillment scheduling system 206 utilizes the purchase orders, user requests, fulfillment data, and/or the fulfillment order data to determined predicted fulfillment times.

In some embodiments, the hosted fulfillment predictor system 502 is scalable to provide a plurality of predicted fulfillment times (e.g., fulfillment times 504). In some embodiments, the hosted fulfillment predictor system 502 is configured to generate hundreds of predicted fulfillment times at a time, thousands of predicted fulfillment times at a time, tens of thousands of predicted fulfillment times at a time, etc. The number of generated predicted fulfillment times is based on the purchase orders and/or user requests received. In some embodiments, the purchase orders and/or user requests are received in batches.

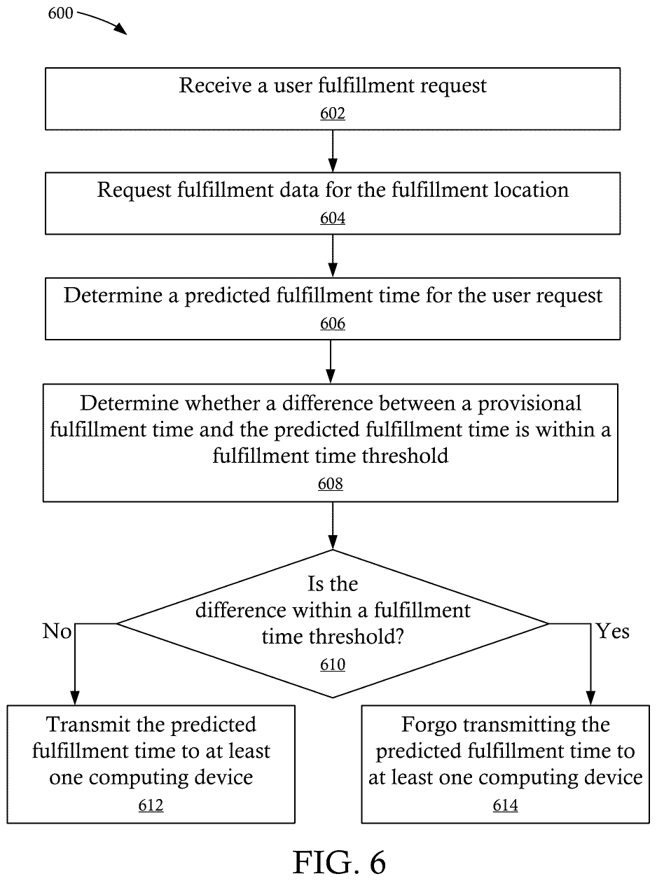

FIGS. 6-8 depict example methods for determining a predicted fulfillment time, in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 6-8 may be implemented in the form of executable instructions stored on machine-readable media and executed by a processing resource and/or in the form of electronic circuitry. For example, aspects of the methods may be described below as being performed by a fulfillment scheduling computing device 102, an example of which may be a fulfillment predictor 132 running on a hardware processing resource 104 of the fulfillment scheduling computing device 102 described above in reference to FIG. 1. Additionally, other aspects of the methods described below may be described with reference to other elements shown in FIG. 1 for non-limiting illustration purposes.

FIG. 6 depicts a flow diagram of a method for determining a predicted fulfillment time, in accordance with some embodiments. The method 600 includes receiving (602) a user fulfillment request. The user fulfillment request can include one or more task requests, item requests, element requests, service requests, fulfilment locations, and/or provisional fulfillment times. In some embodiments, the fulfilment locations and/or the provisional fulfillment times are automatically selected for a user. For example, the fulfilment locations can be selected by a current position of a user (e.g., determined by sensor data and/or user shared data) and locations within a predetermined distance from the current position of a user (e.g., within a 5-mile radius, 10-mile radius, etc.). The provisional fulfillment times (tentative time for completing the request) can be selected by the next available time slot, the latest time slot available, a user preferred time slot, and/or a schedule shared by the user.

The method 600 includes requesting (604) fulfillment data for the fulfillment location. The fulfillment data includes ongoing fulfillment orders at the fulfillment location, information about the fulfillment location (e.g., pick times, inventory, personnel numbers, etc.). The method 600 includes determining (606) a predicted fulfillment time for the user request. The predicted fulfillment time is based on the user request and/or the fulfillment data for the fulfillment location. The determination of the predicted fulfillment time is described above in reference to FIGS. 1-5.

The method 600 includes determining (608) whether a difference between a provisional fulfillment time and the predicted fulfillment time is within a fulfillment time threshold. The method 600, at operation 610, in accordance with a determination that the predicted fulfillment time is within the fulfillment time threshold, the method 600 includes transmitting (612) the predicted fulfillment time to at least one computing device. Alternatively, the method 600, at operation 610, in accordance with a determination that the predicted fulfillment time is outside the fulfillment time threshold, the method 600 includes forgoing (614) transmitting the predicted fulfillment time to at least one computing device.

In some embodiments, the operations of method 600 are performed for each fulfillment time window (e.g., T-15, T-20, T-40, etc.). The operations of method 600 can be performed in real-time and as such, the operations of method 600 can be performed near or at the beginning of each fulfillment time window. For example, in some embodiments, the operations of method 600 can complete in less than 0.2 seconds.

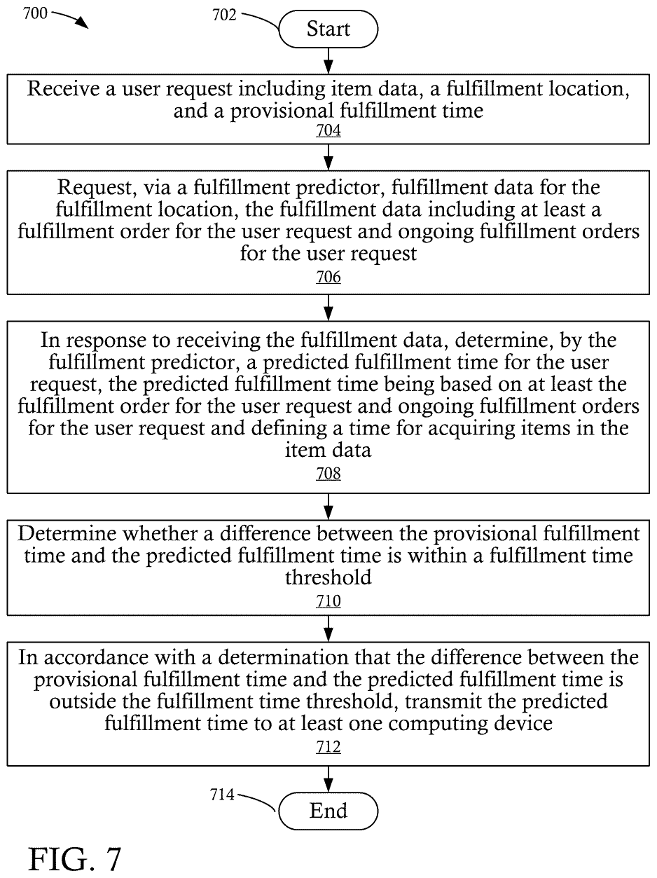

FIG. 7 depicts an example method for determining a predicted fulfillment time, in accordance with some embodiments. The method 700 starts at operation (702) and proceeds to operation (704). Operation (704) includes receiving a user request including item data, a fulfillment location, and a provisional fulfillment time. The method 700 proceeds to operation (706), which includes requesting, via a fulfillment predictor, fulfillment data for the fulfillment location. The fulfillment data includes at least a fulfillment order for the user request and ongoing fulfillment orders for user request.

The method 700 proceeds to operation (708). Operation (708) includes, in response to receiving the fulfillment data, determining, by the fulfillment predictor, a predicted fulfillment time for the user request. The predicted fulfillment time is based on at least the fulfillment order for the user request and ongoing fulfillment orders for the user request and defines a time for acquiring items in the item data. The method 700 proceeds to operation (710) and determines whether a difference between the provisional fulfillment time and the predicted fulfillment time is within a fulfillment time threshold. The method 700 then proceeds to operation (712), which includes, in accordance with a determination that the difference between the provisional fulfillment time and the predicted fulfillment time is outside the fulfillment time threshold, transmitting the predicted fulfillment time to at least one computing device. After operation (712), the method 700 ends (714).

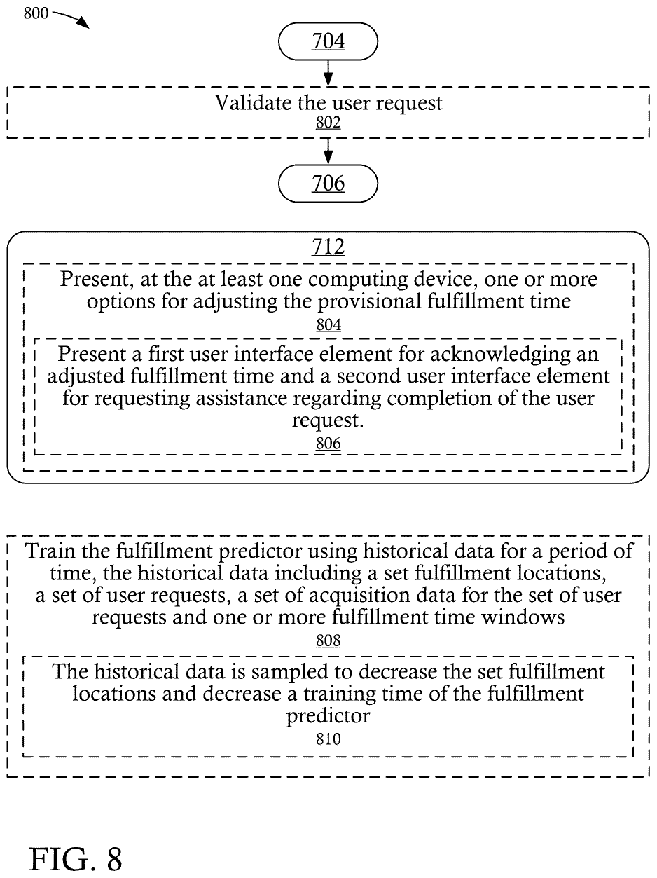

FIG. 8 depicts an example method expanding on the method for determining a predicted fulfillment time, in accordance with some embodiments. The method 800 includes one or more operations that run in conjunction with, before, and/or after one or more operations of method 700. As indicated above, in some embodiments, one or more blocks of the methods may be executed substantially concurrently and/or in a different order than shown. In some embodiments, the method 800 includes operations (802), which includes validating the user request. The operation (802) can be performed between operations (704) and (706) of method 700.

In some embodiments, the method 800 includes operation (804), which includes presenting, at the at least one computing device, one or more options for adjusting the provisional fulfillment time. In some embodiments, the method 800 includes operation (806). Operation (806) includes presenting a first user interface element for acknowledging an adjusted fulfillment time and a second user interface element for requesting assistance regarding completion of the user request. In some embodiments, operation (804) and (806) are performed in conjunction or as part of operation (712) of method 700.

In some embodiments, the method 800 includes operation (808). Operation (808) includes training the fulfillment predictor using historical data for a period of time. The historical data includes a set fulfillment locations, a set of user requests, a set of acquisition data for the set of user requests and one or more fulfillment time windows. In some embodiments, the method 800 include operation (810). Operation (810) samples the historical data such that the set fulfillment locations is decreased, and training time of the fulfillment predictor is decreased.

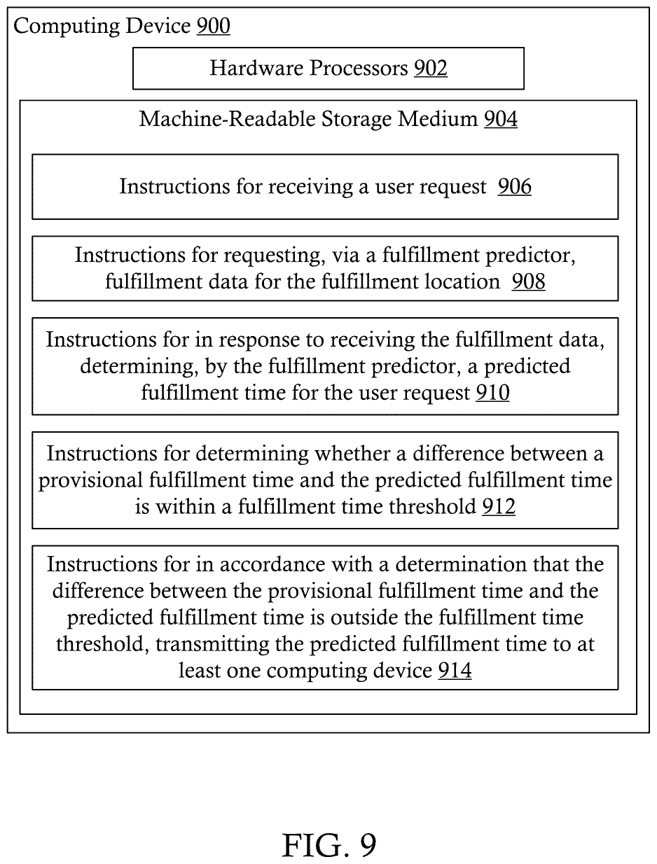

FIG. 9 depicts an example system 900 that includes non-transitory, machine-readable media 904 encoded with example instructions executable by processing resource 902. In some implementations, the system 900 may be useful for implementing aspects of the fulfillment scheduling computing device 102 of FIG. 1 and analogous systems (e.g., the fulfillment scheduling system 206; FIG. 2). For example, the instructions encoded on machine-readable media 904 may be included in instructions 108 of FIG. 1. In some implementations, functionality described with respect to FIG. 1 may be included in the instructions encoded on machine-readable media 904.

The processing resource 902 may include a microcontroller, a microprocessor, central processing unit core(s), an ASIC, an FPGA, and/or other hardware device suitable for retrieval and/or execution of instructions from the machine-readable media 904 to perform functions related to various examples. Additionally or alternatively, the processing resource 902 may include or be coupled to electronic circuitry or dedicated logic for performing some or all of the functionality of the instructions described herein.

The machine-readable media 904 may be any medium suitable for storing executable instructions, such as RAM, ROM, EEPROM, flash memory, a hard disk drive, an optical disc, or the like. In some example implementations, the machine-readable media 904 may be a tangible, non-transitory medium. The machine-readable media 904 may be disposed within the system 900 respectively, in which case the executable instructions may be deemed installed or embedded on the system. Alternatively, the machine-readable media 904 may be a portable (e.g., external) storage medium, and may be part of an installation package.

As described further herein below, the machine-readable media 904 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 9.

With reference to FIG. 9, the machine-readable media 904 includes instructions 906-914. Instructions 906, when executed, cause the processing resource 902 to receive a user request. Instructions 908, when executed, cause the processing resource 902 to request, via a fulfillment predictor, fulfillment data for the fulfillment location. Instructions 910, when executed, cause the processing resource 902, in response to receiving the fulfillment data, determine, by the fulfillment predictor, a predicted fulfillment time for the user request.

Instructions 912, when executed, cause the processing resource 902 determine whether a difference between a provisional fulfillment time and the predicted fulfillment time is within a fulfillment time threshold. Instructions 914, when executed, cause the processing resource 902, in accordance with a determination that the difference between the provisional fulfillment time and the predicted fulfillment time is outside the fulfillment time threshold, transmit the predicted fulfillment time to at least one computing device.

In some embodiments, training data is generated for one or more models (e.g., machine learning models, deep learning models, statistical models, algorithms, etc.) based on historical data and features described above in reference to FIG. 3. One or more models are trained based on corresponding training data. The trained models may be stored in a database, such as in the database 122 (e.g., a cloud storage database).

The models, when executed by the fulfillment scheduling computing device 102, allow the fulfillment scheduling computing device 102 to determine a predicted fulfillment time. For example, the fulfillment scheduling computing device 102 may obtain one or more models from the database 122. In response to receiving a user request, the fulfillment scheduling computing device 102 may execute one or more models to determine and transmit a predicted fulfillment time. A user computing device 126 may then receive, in real-time, a predicted fulfillment time including one or more options for acknowledging changes to a user request and/or modifying a user request.

In some embodiments, the fulfillment scheduling computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, fulfillment scheduling computing device 102 may generate predicted fulfillment times for multiple users and/or for a plurality of fulfillment time windows.

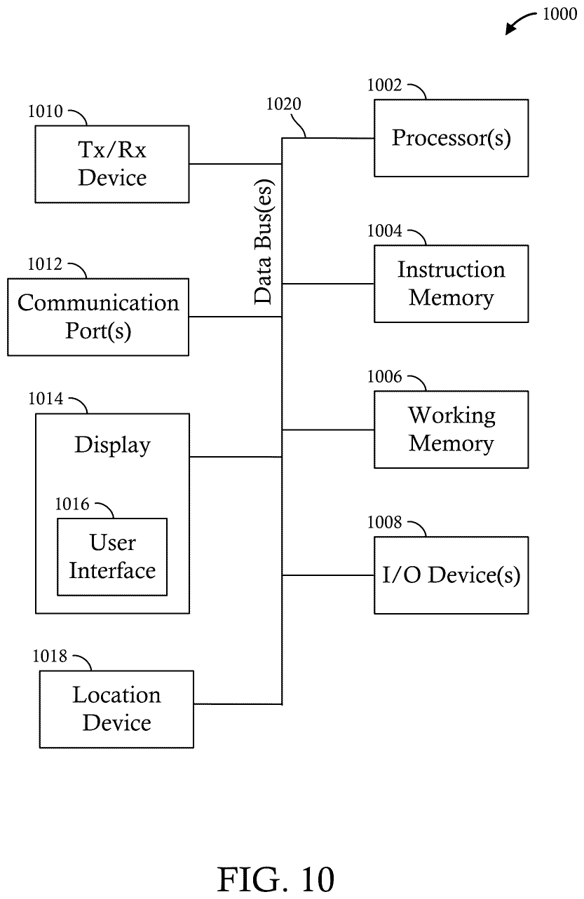

FIG. 10 illustrates a block diagram of a computing device 1000, in accordance with some embodiments. Although FIG. 10 is described with respect to certain components shown therein, it will be appreciated that the elements of the computing device 10 may be combined, omitted, and/or replicated. In addition, it will be appreciated that additional elements other than those illustrated in FIG. 10 may be added to the computing device.

As shown in FIG. 10, the computing device 1000 may include one or more processing resources 1002, instruction memory 1004, working memory 1006, input/output devices 1008, transceiver 1010, communication ports 1012, display 1014, optional location device 1018, and/or any other suitable elements each operatively coupled to one or more data buses 1020. The data buses 1020 allow for communication among the various components. The data buses 1020 may include wired, or wireless, communication channels.

The one or more processing resources 1002 may include any processing circuitry operable to control operations of the computing device 1000. In some embodiments, the one or more processing resources 1002 include one or more distinct processors, each having one or more cores (e.g., processing circuits). Each of the distinct processors may have the same or different structure. The one or more processing resources 1002 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1002 may also be implemented by a controller, a microcontroller, an application specific integrated circuit (ASIC), a field programmable gate array (FPGA), a programmable logic device (PLD), etc.

In some embodiments, the one or more processing resources 1002 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1004 may store instructions that are accessed (e.g., read) and executed by at least one of the one or more processing resources 1002. For example, the instruction memory 1004 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1002 may perform a certain function or operation by executing code, stored on the instruction memory 1004, embodying the function or operation. For example, the one or more processing resources 1002 may execute code stored in the instruction memory 1004 to perform one or more of any function, method, or operation disclosed herein.

Additionally, the one or more processing resources 1002 may store data to, and read data from, the working memory 1006. For example, the one or more processing resources 1002 may store a working set of instructions to the working memory 1006, such as instructions loaded from the instruction memory 1004. The one or more processing resources 1002 may also use the working memory 1006 to store dynamic data created during one or more operations. The working memory 1006 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 1004 and working memory 1006, it will be appreciated that the computing device 1000 may include a single memory unit that operates as both instruction memory and working memory. Further, although embodiments are discussed herein including non-volatile memory, it will be appreciated that computing device 1000 may include volatile memory components in addition to at least one non-volatile memory component.

In some embodiments, the instruction memory 1004 and/or the working memory 1006 includes an instruction set, in the form of a file for executing various methods, such as methods for determining a predicted fulfillment time, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, . NET, HTML, CSS, SQL, NoSQL, Rust, Perl, etc. In some embodiments a compiler or interpreter converts the instruction set into machine executable code for execution by the one or more processing resources 1002.

The input/output devices 1008 may include any suitable device that allows for data input or output. For example, the input/output devices 1008 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1010 and/or the communication port(s) 1012 allow for communication with a network. For example, if a communication network is a cellular network, the transceiver 1010 allows communications with the cellular network. In some embodiments, the transceiver 1010 is selected based on the type of the communication network the computing device 1000 will be operating in. The one or more processing resources 1002 are operable to receive data from, or send data to, a network, via the transceiver 1010.

The communication port(s) 1012 may include any suitable hardware, software, and/or combination of hardware and software that is capable of coupling the computing device 1000 to one or more networks and/or additional devices. The communication port(s) 1012 may be arranged to operate with any suitable technique for controlling information signals using a desired set of communications protocols, services, or operating procedures. The communication port(s) 1012 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1012 allows for the programming of executable instructions in the instruction memory 1004. In some embodiments, the communication port(s) 1012 allow for the transfer (e.g., uploading or downloading) of data, such as machine learning model training data.

In some embodiments, the communication port(s) 1012 couples the computing device 1000 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1010 and/or the communication port(s) 1012 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1014 may be any suitable display, and may display the user interface 1016. The user interfaces 1016 may enable user interaction with fulfillment scheduling computing device 102, input features, and/or other communicatively coupled devices. For example, the user interface 1016 may be a user interface for an application of a network environment operator that allows a user to view and interact with the operator's website. In some embodiments, a user may interact with the user interface 1016 by engaging the input/output devices 1008. In some embodiments, the display 1014 may be a touchscreen, where the user interface 1016 is displayed on the touchscreen.

The display 1014 may include a screen such as, for example, a Liquid Crystal Display (LCD) screen, a light-emitting diode (LED) screen, an organic LED (OLED) screen, a movable display, a projection, etc. In some embodiments, the display 1014 may include a coder/decoder, also known as Codecs, to convert digital media data into analog signals. For example, the visual peripheral output device may include video Codecs, audio Codecs, or any other suitable type of Codec.

The optional location device 1018 may be communicatively coupled to a location network and operable to receive position data from the location network. For example, in some embodiments, the location device 1018 includes a GPS device that receives position data identifying a latitude and longitude from one or more satellites of a GPS constellation. As another example, in some embodiments, the location device 1018 is a cellular device that receives location data from one or more localized cellular towers. Based on the position data, the computing device 1000 may determine a local geographical area (e.g., town, city, state, etc.) of its position.

In some embodiments, the computing device 1000 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1000 may be a computer, a workstation, a laptop, a server such as a cloud-based server, or any other suitable device. In some embodiments, the computing device 1000 is a server that includes one or more processing units, such as one or more graphical processing units (GPUs), one or more central processing units (CPUs), and/or one or more processing cores. The computing device 1000 may, in some embodiments, execute one or more virtual machines. In some embodiments, processing resources (e.g., capabilities) of the computing device 1000 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Training models based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

Systems including trained fulfillment predictors, as disclosed herein, significantly reduce errors in estimated fulfillment times and reduce processing demands and time spend determining estimated fulfillment times, allowing for reduced errors and negative interactions with user with fewer, or in some case no, active steps. For example, in some embodiments described herein, when a user is presented with options for adjusting provisional fulfillment times, each interface element includes, or is in the form of, a link to an interface page for modifying a user request. Each recommendation thus serves as a programmatically selected navigational shortcut to an interface page, allowing a user to bypass the navigational structure of the browse tree. Beneficially, programmatically identifying one or more options for adjusting the provisional fulfillment times and presenting a user with navigations shortcuts to these tasks may improve the speed of the user's navigation through an electronic interface, rather than requiring the user to page through multiple other pages in order to modify a user request via the browse tree or via a search function. This may be particularly beneficial for computing devices with small screens, where fewer interface elements are displayed to a user at a time and thus navigation of larger volumes of data is more difficult.

It will be appreciated that the determination of predicted fulfillment times as disclosed herein, particularly based on large datasets intended to be used with a fulfillment predictor, is only possible with the aid of computer-assisted machine-learning algorithms and techniques. In some embodiments, machine learning processes including feature derivations and generation are used to perform operations that cannot practically be performed by a human, either mentally or with assistance. It will be appreciated that a variety of machine learning techniques can be used alone or in combination to generate a fulfillment predictor.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a user request including:
i) item data,
ii) a fulfillment location, and
iii) a provisional fulfillment time;
request, via a fulfillment predictor, fulfillment data for the fulfillment location, the fulfillment data including at least a fulfillment order for the user request and ongoing fulfillment orders for the user request;
in response to receiving the fulfillment data, determine, by the fulfillment predictor, a predicted fulfillment time for the user request, wherein the predicted fulfillment time is based on at least the fulfillment order for the user request and ongoing fulfillment orders for the user request and defines a time for acquiring items in the item data;
determine whether a difference between the provisional fulfillment time and the predicted fulfillment time is within a fulfillment time threshold; and
in accordance with a determination that the difference between the provisional fulfillment time and the predicted fulfillment time is outside the fulfillment time threshold, transmit the predicted fulfillment time to at least one computing device.

2. The system of claim 1, wherein transmitting the predicted fulfillment time to the at least one computing device includes presenting, at the at least one computing device, one or more options for adjusting the provisional fulfillment time.

3. The system of claim 2, wherein presenting, at the at least one computing device, the one or more options for adjusting the provisional fulfillment time includes presenting:
a first user interface element for acknowledging an adjusted fulfillment time; and
a second user interface element for requesting assistance regarding completion of the user request.

4. The system of claim 1, wherein the instructions, when executed, further cause the processor to:
validate the user request before determining the predicted fulfillment time.

5. The system of claim 1, wherein the instructions, when executed, further cause the processor to:
train the fulfillment predictor, wherein the fulfillment predictor is trained using historical data for a period of time, the historical data including:
a set fulfillment locations,
a set of user requests,
a set of acquisition data for the set of user requests, and
one or more fulfillment time windows.

6. The system of claim 5, wherein the historical data is sampled to decrease the set fulfillment locations and decrease a training time of the fulfillment predictor.

7. The system of claim 1, wherein the fulfillment predictor provides a value for the predicted time having an accuracy rate of a predefined threshold value within a predefined time window with respect to an actual pick completion time.

8. A computer-implemented method, comprising:
receiving a user request including:
i) element data,
ii) a fulfillment location, and
iii) a provisional fulfillment time;
requesting, via a fulfillment predictor, fulfillment data for the fulfillment location, the fulfillment data including at least a fulfillment order for the user request and ongoing fulfillment orders for the user request;
in response to receiving the fulfillment data, determining, by the fulfillment predictor, a predicted fulfillment time for the user request, wherein the predicted fulfillment time is based on at least the fulfillment order for the user request and ongoing fulfillment orders for the user request and defines a time for acquiring elements in the element data;
determining whether a difference between the provisional fulfillment time and the predicted fulfillment time is within a fulfillment time threshold; and
in accordance with a determination that the difference between the provisional fulfillment time and the predicted fulfillment time is outside the fulfillment time threshold, transmitting the predicted fulfillment time to at least one computing device.

9. The computer-implemented method of claim 8, wherein transmitting the predicted fulfillment time to the at least one computing device includes presenting, at the at least one computing device, one or more options for adjusting the provisional fulfillment time.

10. The computer-implemented method of claim 9, wherein presenting, at the at least one computing device, the one or more options for adjusting the provisional fulfillment time includes presenting:
a first user interface element for acknowledging an adjusted fulfillment time; and
a second user interface element for requesting assistance regarding completion of the user request.

11. The computer-implemented method of claim 8, further comprising:
validating the user request before determining the predicted fulfillment time.

12. The computer-implemented method of claim 8, further comprising:
training the fulfillment predictor, wherein the fulfillment predictor is trained using historical data for a period of time, the historical data including:
a set fulfillment locations,
a set of user requests,
a set of acquisition data for the set of user requests; and
one or more fulfillment time windows.

13. The computer-implemented method of claim 12, wherein the historical data is sampled to decrease the set fulfillment locations and decrease a training time of the fulfillment predictor.

14. The computer-implemented method of claim 8, wherein the fulfillment predictor provides a value for the predicted time having an accuracy rate of a predefined threshold value within a predefined time window with respect to an actual pick completion time.

15. A non-transitory computer readable medium having instructions stored thereon, wherein the instructions, when executed by at least one processor, cause at least one device to perform operations comprising:
receiving a user request including:
i) item data,
ii) a pickup location, and
iii) a provisional pickup time;
requesting, via a pickup predictor, pickup data for the pickup location, the pickup data including at least a pickup order for the user request and ongoing pickup orders for the user request;
in response to receiving the pickup data, determining, by the pickup predictor, a predicted pickup time for the user request, wherein the predicted pickup time is based on at least the pickup order for the user request and ongoing pickup orders for the user request and defines a time for acquiring items in the item data;
determining whether a difference between the provisional pickup time and the predicted pickup time is within a pickup time threshold; and
in accordance with a determination that the difference between the provisional pickup time and the predicted pickup time is outside the pickup time threshold, transmitting the predicted pickup time to at least one computing device.

16. The non-transitory computer readable medium of claim 15, wherein transmitting the predicted pickup time to the at least one computing device includes presenting, at the at least one computing device, one or more options for adjusting the provisional pickup time.

17. The non-transitory computer readable medium of claim 16, wherein presenting, at the at least one computing device, the one or more options for adjusting the provisional pickup time includes presenting:
a first user interface element for acknowledging an adjusted pickup time; and
a second user interface element for requesting assistance regarding completion of the user request.

18. The non-transitory computer readable medium of claim 15, wherein the instructions, when executed by the at least one processor, further cause the at least one device to perform operations comprising:
validating the user request before determining the predicted pickup time.

19. The non-transitory computer readable medium of claim 15, wherein the instructions, when executed by the at least one processor, further cause the at least one device to perform operations comprising:
training the pickup predictor, wherein the pickup predictor is trained using historical data for a period of time, the historical data including:
a set pickup locations,
a set of user requests,
a set of acquisition data for the set of user requests; and
one or more pickup time windows.

20. The non-transitory computer readable medium of claim 15, wherein the fulfillment predictor provides a value for the predicted time having an accuracy rate of a predefined threshold value within a predefined time window with respect to an actual pick completion time.
